(19) United States
(12) Patent Application Publication
(10) Pub. No.: US 2023/0107050 A1
(43) Pub. Date: Apr. 6, 2023

(54) Wheel and Motor Vehicle Comprising a Wheel

(71) Applicant: Bayerische Motoren Werke Aktiengesellschaft, Muenchen (DE)

(72) Inventors: Rudolf DITTRICH, Woerthsee (DE); Simon SCHMITT, Schoefweg (DE)

(21) Appl. No.: 17/800,003

(22) PCT Filed: Jan. 18, 2021
(86) PCT No.: PCT/EP2021/050883

§ 371 Date: Aug. 16, 2022

(30) Foreign Application Priority Data
Feb. 19, 2020 (DE) 10 2020 104 305.8

(51) Int. Cl. B60B 1/14

(52) U.S. Cl. CPC B60B 1/14; B60B 2900/572; B60B 2900/1216

(57) ABSTRACT

A wheel for a two-track motor vehicle has a rim, a hub, and multiple spokes arranged distributed in the circumferential direction and each having a radially inner end and a radially outer end. The hub is arranged asymmetrically relative to a vertical wheel central plane extending perpendicular to a rotational axis direction of the wheel. Each spoke is connected to the rim by its respective radially outer end and connected to the hub by its radially inner end, such that the rim is connected to the hub via the spokes. In terms of a functional installation state of the wheel in a vehicle, at least two of the spokes are secured to the rim with their radially outer ends in different positions in the vehicle transverse direction and/or at least two of the spokes are secured to the hub with their radially inner ends in different positions in the vehicle transverse direction.

### BACKGROUND AND SUMMARY

The invention relates to a wheel, preferably for a two-track motor vehicle, in particular for a passenger car, having a rim, a hub and a plurality of spokes arranged in a distributed manner in the circumferential direction and each having a radially inner end and a radially outer end, wherein the hub is arranged asymmetrically to a vertical wheel center plane extending perpendicularly to a rotation axis direction of the wheel, wherein each spoke is connected to the rim by its radially outer end and to the hub by its radially inner end, such that the rim is connected to the hub by the spokes.

Wheels of the type in question are known in principle from the prior art, in particular motor vehicle wheels having specified geometries for advantageously influencing aerodynamics or for an advantageous flow on or around the motor vehicle wheel during travel, for example from DE 10 2016 216 536 A1.

In particular, it is known to choose the geometry of the wheel in such a way that an aerodynamic rotation (resistance) moment occurring during travel is reduced in order to have a positive influence on an aerodynamic resistance of the vehicle as a whole. For this purpose, the prior art discloses various measures, for example a full-surface or part-surface, in particular annular disk-shaped covering of the wheel on the outer side, in particular from the outer rim edge, or specific spoke geometries, as proposed in the aforementioned DE 10 2016 216 536 A1, for example.

In many cases, however, an implementation of the measures known from the prior art is not possible or is not desired for visual reasons, for example owing to the associated design which is perceived to be disadvantageous, or for technical reasons (brake ventilation, weight, regulations in motorsport, etc.).

Against this background, it is an object of the present invention to provide an alternative, in particular improved, wheel and an alternative, in particular improved, motor vehicle.

This object is achieved by a wheel and by a motor vehicle having the features of the independent claims. Advantageous and preferred embodiments of the invention form the subject matter of the dependent claims and will be explained in detail below. The wording of the claims is included in the content of the description by express reference.

A wheel according to the invention is characterized in that, with respect to a functional installation state of the wheel in a vehicle, at least two of the spokes are fastened to the rim by their radial outer end at different positions in the vehicle transverse direction, that is to say in the rotation axis direction, and/or at least two of the spokes are fastened to the hub by their radially inner end at different positions in the vehicle transverse direction.

The arrangement according to the invention of the spokes, which particularly advantageously utilizes an installation space available within the rim, allows a particularly advantageous aerodynamic configuration of a wheel for a motor vehicle, in particular with a visually appealing design and without significant disadvantages in terms of the strength of the wheel. Furthermore, such a wheel allows good brake ventilation.

Specifically, the configuration according to the invention of a wheel allows the arrangement of more spokes between the hub and rim and consequently a distribution over more spokes of the forces and moments to be supported or transmitted. Consequently, a smaller dimensioning of the individual spokes is possible, in particular with varying width over their length or a narrower configuration of the spokes. This can result, in turn, in a particularly good brake ventilation being achieved and moreover in a visually very appealing manner. For example, as will be shown later by way of the exemplary embodiments, a wheel having ten spokes can be provided which allows a smaller dimensioning of the individual spokes, in particular narrower spokes, by comparison with a wheel having only five spokes, with the result that a good brake ventilation can be achieved but, which in spite of the ten spokes, visually rather gives the impression of a five-spoke wheel.

What is to be understood here in the present case by a “wheel center plane” is a plane which intersects the wheel in its center.

What is to be understood by an asymmetrically arranged hub in the present case and within the meaning of the invention here is a hub which is not arranged in the vehicle transverse direction centrally within the rim, as, for example, in the case of a conventional motorcycle rim, but is offset in particular in the vehicle transverse direction from the center of the wheel or the rim, with it being the case that, in a wheel according to the invention, the hub is offset toward the vehicle exterior in the vehicle transverse direction, with respect to a functional installation state of the wheel in a vehicle.

With particular preference, a wheel according to the invention here has at most sixteen spokes, preferably at most twelve spokes, in particular at most ten, eight or six spokes, but at least two spokes, preferably at least three spokes.

Here, each spoke can in principle be a single spoke, or else can be designed as a double spoke at least partially over its length in the circumferential direction and/or in the rotation axis direction.

In an advantageous embodiment of a wheel according to the invention, with respect to a functional installation state of the wheel in a vehicle, two spokes arranged adjacently in the circumferential direction are fastened to the rim by their radially outer end at different positions in the vehicle transverse direction and/or fastened to the hub by their radially inner end at different positions in the vehicle transverse direction.

As a result, a particularly advantageous aerodynamic configuration of a wheel can be achieved that in particular additionally allows good brake ventilation and/or permits a visually appealing configuration.

In a further advantageous embodiment of a wheel according to the invention, the wheel has at least two groups of spokes: a first group of spokes whose radially outer end is in each case fastened to the rim at a first position in the vehicle transverse direction along a first rim circumferential circle, and at least one second group of spokes whose radially outer end is in each case fastened to the rim at a second position in the vehicle transverse direction along a second rim circumferential circle. This makes it possible to achieve a particularly advantageous aerodynamic configuration of a wheel.

Here, the rim circumferential circle is that circle which runs through all attachment points of the spokes for the associated group on the rim, wherein the rim circumferential circle preferably in each case lies in a plane perpendicular to the rotation axis of the wheel.

Here, a group preferably comprises at least two spokes, in particular at least three spokes, but at most preferably eight spokes, in particular at most seven, six, five or four spokes.

In a further advantageous embodiment of a wheel according to the invention, in particular in a development, the wheel has at least two groups of spokes: a first group of spokes whose radially inner end is in each case fastened to the hub at a first position in the vehicle transverse direction along a first hub circumferential circle, and at least one second group of spokes whose radially inner end is in each case fastened to the hub at a second position in the vehicle transverse direction along a second hub circumferential circle. This makes it possible to achieve a particularly advantageous aerodynamic configuration of a wheel.

Here, the hub circumferential circle is that circle which runs through all attachment points of the spokes of the associated group on the hub, wherein the hub circumferential circle preferably in each case lies in a plane perpendicular to the rotation axis of the wheel.

In a further advantageous embodiment of a wheel according to the invention, in particular in a development, at least one first spoke of the first group, in particular all the spokes of this group, is or are fastened to the rim by its or their radially outer end along the first rim circumferential circle and to the hub by its or their radially inner end along the first hub circumferential circle, and preferably at least one second spoke of the second group, in particular a spoke arranged adjacently to a first spoke in the circumferential direction, is fastened to the rim by its radially outer end along the second rim circumferential circle and to the hub by its radially inner end along the second hub circumferential circle. This makes it possible to achieve a particularly advantageous aerodynamic configuration of a wheel.

In a further advantageous embodiment of a wheel according to the invention, in particular in a development, the spokes of the first group and the spokes of the second group are arranged in a regularly alternating manner, preferably by turns, in particular in such a way that in each case a spoke from the first group is followed with a defined regularity by a spoke from the second group, in particular directly, that is to say without one or more intermediate spokes.

This makes it possible to achieve a particularly advantageous aerodynamic configuration of a wheel. The regularity also makes it possible in particular to reduce or even completely avoid the risk of the occurrence of irregular forces and moments which can lead to an unbalance.

With particular preference, the spokes are arranged here in such a way that the spokes are fastened to the rim in the circumferential direction by their radially outer end in each case in a regularly alternating manner, in particular by turns, in the circumferential direction along the first rim circumferential circle and the second rim circumferential circle and/or are fastened to the hub by their radially inner end in each case in a regularly alternating manner, in particular by turns, in the circumferential direction along the first hub circumferential circle and the second hub circumferential circle. This allows a particularly advantageous configuration with respect to the aerodynamics of the wheel.

In a further advantageous embodiment of a wheel according to the invention, in particular in a development, at least one first spoke extends from the hub up to the rim with its longitudinal axis at a first defined angle to the rotation axis, in particular from the hub obliquely radially outward and toward the vehicle interior up to the rim, and at least one second spoke, in particular a spoke arranged adjacently to a first spoke in the circumferential direction, extends from the hub up to the rim with its longitudinal axis at a second defined angle to the rotation axis, in particular from the hub obliquely radially outward and toward the vehicle exterior up to the rim, wherein at least one first spoke and/or at least one second spoke preferably extend or extends in a plane which is common with the rotation axis.

Here, the first angle and the second angle are in each case the smaller angle between the rotation axis of the wheel and the longitudinal axis of the respective spoke, that is to say an “internal angle”.

Preferably, in each case a plurality of spokes of a group extend at the same angle, in particular all the spokes of a group. This makes it possible in a particularly simple manner to achieve a regular arrangement and thus a particularly uniform distribution of the forces, in particular in the circumferential direction.

It has been shown that it is particularly advantageous if the first angle and the second angle are each less than 90°, in particular less than 80°, 75°, 70°, 60° or 50°. However, it is advantageous in most cases if the first angle and the second angle are each at least 45°. In many cases, it is particularly advantageous if the first angle and the second angle are at least 50°, 60°, 70° or 75°. As a result, an advantageous aerodynamic configuration of the wheel can be achieved with good supporting or transmission of the occurring forces and moments.

In a further advantageous embodiment of a wheel according to the invention, in particular in a development, the first angle and the second angle have the same angular magnitudes.

By contrast, in an alternative, but in many cases likewise advantageous embodiment of a wheel according to the invention, the first angle and the second angle have different angular magnitudes.

The supporting or transmission of forces and moments between the rim and hub can be influenced via the angle at which the spokes extend between the hub and rim. Depending on the application, identical or different angular magnitudes can be advantageous here, in particular with respect to the strength of the wheel.

If, in a wheel according to the invention, for example a first spoke extends at a first angle from the hub obliquely radially outward and toward the vehicle interior up to the rim and a second spoke adjacent to the first spoke extends at a second angle with the same angular magnitude from the hub obliquely radially outward and toward the vehicle exterior up to the rim, a X-shaped, V-shaped (normal or inverted, that is to say roof-shaped) or trapezoidal arrangement of the spokes results when considering a radial section through the wheel along a section plane containing the rotation axis of the wheel and with a projection of the two spokes in the circumferential direction into the section plane. As a result, an advantageous aerodynamic configuration of the wheel can be achieved with good supporting or transmission of the occurring forces and moments.

Therefore, in a further advantageous embodiment of a wheel according to the invention, in particular in a development, with respect to a functional installation state of the wheel in a vehicle, a distance in the vehicle transverse direction between the first rim circumferential circle and the second rim circumferential circle and also a distance between the first hub circumferential circle and the second hub circumferential circle and also the first angle and the second angle are in particular in each case chosen in such a way that, when considering a radial section through the wheel along a section plane containing the rotation axis of the wheel, and with a projection in the circumferential direction of two adjacently arranged spokes into the section plane, these spokes form a X, a V, an inverted V or, together with a portion of the rim and a portion of the hub, a quadrangle, in particular a trapezoid.

An embodiment has proved to be particularly advantageous in which the spokes are arranged in an alternating manner and in each case two spokes adjacent in the circumferential direction form an X, wherein the two spokes particularly preferably cross one another in a radially further outward half of a portion between the hub and the rim, in particular in a radially outer third. As a result, a particularly wide supporting base on the hub can be realized. Conversely, a X-shaped arrangement of the spokes, if the latter cross one another closer to the hub, has a narrower supporting base on the hub, but in return a wider supporting base on the rim.

A V-shaped arrangement, that is to say an arrangement with a supporting base of zero on the hub (that is to say the attachment points of the two spokes on the hub lie on the same hub circumferential circle) leads to concentrated supporting of the forces and moments, but can also be advantageous in some cases. In the case of an arrangement in the form of an inverted V, there correspondingly results a supporting base of zero on the rim. That is to say that the attachment points of the two spokes on the rim in this case lie on the same rim circumferential circle, which can likewise be indeed advantageous in some cases. It can also be advantageous in some cases to have a trapezoidal arrangement with a supporting base on the rim and on the hub which is different from zero in each case and in which the spokes do not cross one another with a projection, as described above, into the radial section plane, with it being the case here that the supporting base on the hub can be larger or the supporting base on the rim. That is to say that both are possible in principle.

The configuration and arrangement or the profile of the spokes can also be chosen in such a way that a parallelogram or an irregular quadrangle results.

In a further advantageous embodiment of a wheel according to the invention, in particular in a development, a width in the circumferential direction of at least one spoke increases outwardly in the radial direction with increasing distance from the rotation axis of the wheel, preferably symmetrically to a spoke longitudinal axis. That is to say that the spoke becomes increasingly wider in the circumferential direction outwardly in the radial direction. This makes it possible in a simple manner to achieve an improvement in the aerodynamic properties of the wheel.

However, in an alternative, but in some cases likewise advantageous embodiment of a wheel according to the invention, a width in the circumferential direction of at least one spoke can also decrease outwardly in the radial direction with increasing distance from the rotation axis of the wheel, preferably symmetrically to a spoke longitudinal axis. That is to say that at least one spoke can also become increasingly narrower in its width in the circumferential direction outwardly in the radial direction. This makes it possible in a simple manner to achieve good brake ventilation. Furthermore, spokes which become narrower in the radial direction produce a “light” and “sporty” overall impression of the wheel, which is often desired. That is to say that this makes it possible to achieve a particularly appealing visual design, but one which also allows the technical requirements to be achieved, for example good brake ventilation.

However, in principle, bulging spokes or the like are also conceivable in a wheel according to the invention.

In a further advantageous embodiment of a wheel according to the invention, in particular in a development, the wheel, in particular at least one spoke of the wheel, has at least one further aerodynamic measure. This makes it possible in a simple manner to achieve a further improvement in the aerodynamic properties of the wheel.

For example, one or more of the spokes can additionally be designed partially or completely as a double spoke in the rotation axis direction, for example as in DE 10 2016 216 536 A1 stated at the outset, and/or can have correspondingly suitable flow contours, such as, for example, one or more separation edges and/or dimples (depressions like a golf ball) and/or the like.

Other measures known from the prior art are likewise additionally possible. For example, a wheel according to the invention can have a narrow annular disk which is at least partially or completely closed in the circumferential direction. This can be fastened, for example, to an edge of the rim toward the vehicle exterior, for example similarly to a wheel cap, that is to say further to the vehicle exterior than all the spokes, or else be fastened to an inner wall of the rim, in particular in the vehicle transverse direction between the radially outer attachment points of the first spoke and the second spoke, or even further to the vehicle interior than all the spokes.

A motor vehicle according to the present invention can in particular be a two-track motor vehicle, wherein the motor vehicle has at least one wheel and is characterized in that at least one wheel of the motor vehicle is designed according to the invention.

A wheel according to the invention allows particularly advantageous aerodynamics of the vehicle to be achieved, in particular in the region of the wheel, since, as explained above, the configuration according to the invention of the wheel with the radially inner and/or radially outer ends fastened at different positions in the vehicle transverse direction makes it possible to achieve a particularly advantageous flow around the wheel in each case in the region of these ends.

These and further features will emerge not only from the claims and from the description but also from the drawings, wherein the individual features may be realized in each case individually or severally in the form of sub-combinations in an embodiment of the invention and represent advantageous and independently protectable designs and which lie within the scope of protection sought.

In the following, the invention will be further explained on the basis of two preferred exemplary embodiments, with for this purpose the invention being schematically illustrated in the appended drawings.

### BRIEF DESCRIPTION OF THE DRAWINGS

FIG. 1 shows a first exemplary embodiment of a wheel according to the invention in a perspective illustration;

FIG. 2 is a schematic illustration of a projection of two spokes adjacent in the circumferential direction into a radial section plane extending along the rotation axis; and

FIG. 3 depicts a schematic illustration of such a projection of a second exemplary embodiment of a wheel according to the invention.

Here, all the features described in more detail and also all the discernible features may be essential to the invention.

### DETAILED DESCRIPTION OF THE DRAWINGS

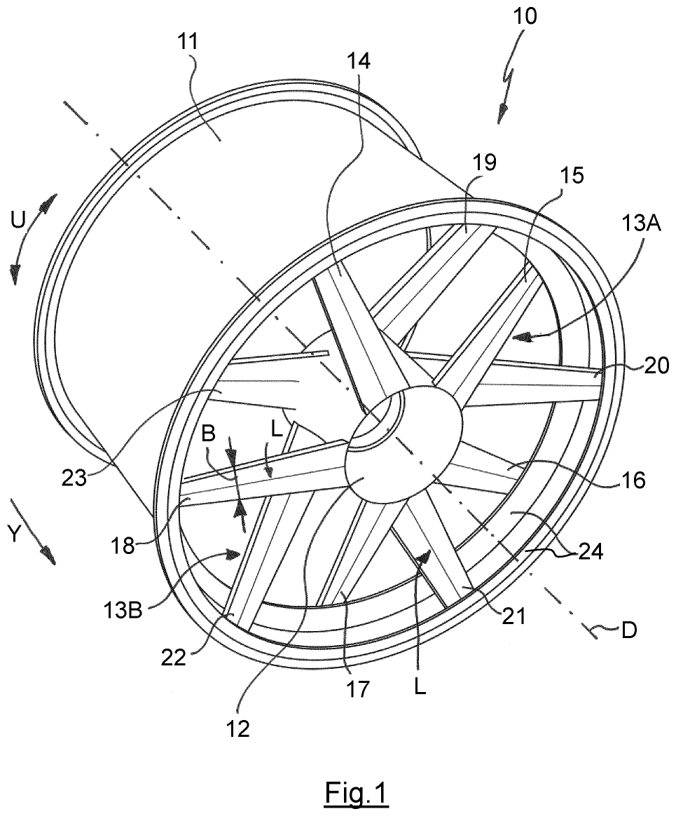

FIG. 1 shows a first exemplary embodiment of a wheel 10 for a two-track motor vehicle, in particular for a passenger car, having a rim 11, a hub 12 and a plurality of spokes 14 to 23 arranged in a uniformly distributed manner in the circumferential direction.

Here, the hub 12 is arranged or designed to be asymmetrical to a wheel center plane (not shown here) extending perpendicularly to a rotation axis direction D or a rotation axis D of the wheel 10 or is arranged to be offset from this wheel center plane in a direction toward the vehicle exterior, that is to say not centrally to the rim or not symmetrically, as is generally customary in the case of motorcycle rims, for example.

Here, the spokes 14 to 23 are each fastened to the hub 12 by their radially inner end (not designated in more detail) and are each fastened to an inner side of the rim 11 by their radially outer end (likewise not designated in more detail). The rim 11 is fixedly connected to the hub 12 by the spokes 14 to 23.

This exemplary embodiment of a wheel 10 has two groups of spokes, namely a first group having the spokes 14 to 18, which are part of a first wheel spider 13A, and a second group of spokes having the spokes 19 to 23, which are part of a second wheel spider 13B.

The spokes 14 to 18 of the first group are here fastened to the hub 12 by their radially inner end in the vehicle transverse direction Y further in the direction toward the vehicle exterior than the spokes 19 to 23 of the second group, that is to say further outward in the +Y direction. By contrast, the spokes 14 to 18 are each fastened to an inner wall of the rim 11 by their radially outer end further in the direction toward the vehicle interior than the spokes 19 to 23 of the second group, that is to say further inward in the −Y direction.

The spokes 14 to 18 of the first group or of the first wheel spider 13A here each extend from the hub 12 obliquely radially outward and toward the vehicle interior up to the rim 11, whereas, by contrast, the spokes 19 to 23 of the second group or of the second wheel spider 13B extend obliquely radially outward and toward the vehicle exterior.

For particularly advantageous aerodynamics of the wheel 10, in particular for further reduction of the aerodynamic rotation (resistance) moment occurring during travel, the spokes 14 to 23 in this wheel 10 are here in each case all fastened within a rim edge 24, that is to say within the rim bowl. Here, the rim wall 24 acts like an aerodynamic annular disk. With appropriate configuration of the rim wall 24, the flow on or around the wheel 10 can be positively influenced in such a way that the aerodynamic rotation (resistance) moment which occurs is reduced.

As can be clearly seen from FIG. 1, the spokes 14 to 18 of the first group or of the first wheel spider 13A and the spokes 19 to 23 of the second group or of the second wheel spider 13B are here arranged in a regularly alternating manner, in particular alternating by turns.

In this exemplary embodiment, the spokes 14 to 23 here each completely extend outwardly away from the rotation axis D in the radial direction, that is to say without a tangential or circumferential component, although this is alternatively also possible in principle in another embodiment of a wheel according to the invention. Thus, for each of the spokes 14 to 23 for the depicted wheel 10 there can be found a plane which intersects both the respective spoke over its entire length and the axis of rotation over the entire width of the wheel 10 in the vehicle transverse direction Y. That is to say that, for each spoke of the spokes 14 to 23, there is a common plane in which both the rotation axis D and the spoke extend.

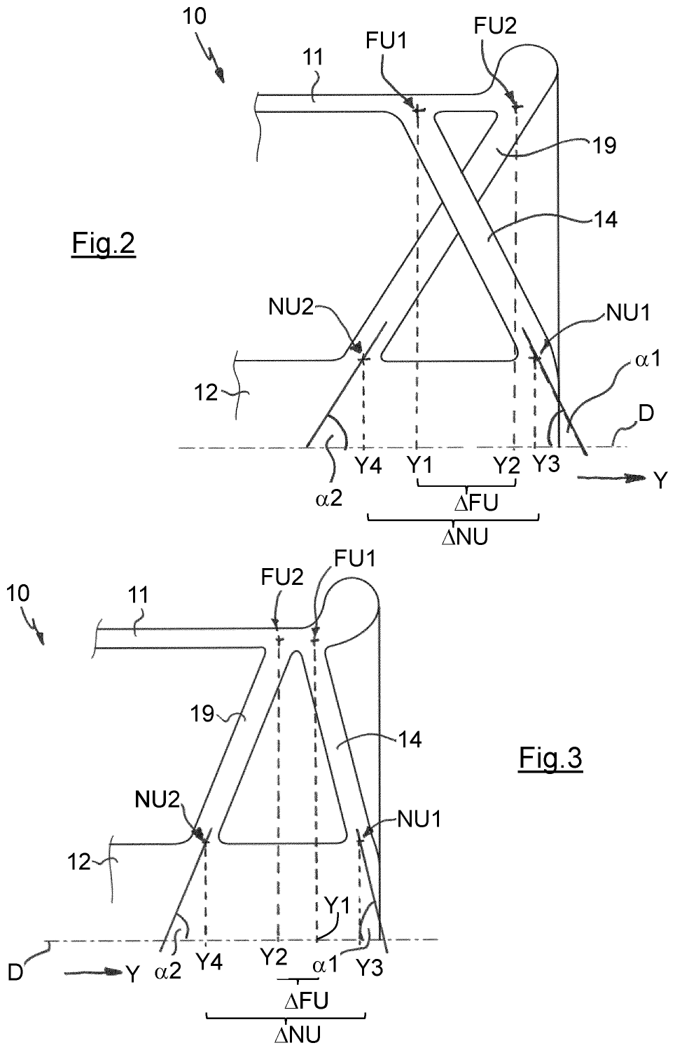

According to the invention, the spokes 14 to 18 of the first group or of the first wheel spider 13A and also the spokes 19 to 23 of the second group or of the second wheel spider 13B are here each fastened to the rim 11 by their radially outer ends at different positions Y1 and Y2 (cf. FIG. 2) in the vehicle transverse direction Y, that is to say in the Y direction, and, in this embodiment of a wheel 10 according to the invention, are additionally fastened to the hub 12 by their radially inner ends in each case at different positions Y3 and Y4 (cf. also FIG. 2) in the vehicle transverse direction Y.

This can clearly be seen on the basis of FIG. 2 which is a schematic illustration showing a projection of the spokes 14 and 19 arranged adjacently in the circumferential direction into a radial section plane extending along the rotation axis D.

In the exemplary embodiment described here of a wheel 10 according to the invention, the radially inner ends of the spokes 14 to 18 of the first group or of the first wheel spider 13A are here each fastened to the hub 12 at the same position Y3 in the vehicle transverse direction Y. That is to say that their attachment positions on the hub 12 all lie on a common hub circumferential circle NU, in particular on a first hub circumferential circle NU1. In principle, however, an arrangement on different hub circumferential circles is also conceivable.

Likewise, the radially outer ends of the spokes 14 to 18 of the first group or of the first wheel spider 13A are all fastened to the rim 11 at the same position in the vehicle transverse direction Y and thus lie on a common rim circumferential circle FU, in particular on a first rim circumferential circle FU1. In principle, an arrangement on different rim circumferential circles is also possible here.

Correspondingly, the spokes 19 to 23 of the second group are likewise attached to the hub 12 by their radially inner ends along a common hub circumferential circle NU, in particular along a second hub circumferential circle NU2, and by their radially outer ends along a common rim circumferential circle FU, in particular along a second rim circumferential circle FU2. Correspondingly, the spokes 19 to 23 can also each be fastened to the rim 11 or the hub 12 at different positions in the Y direction.

In particular, it is also possible for only some of the spokes of a group to be fastened to the rim 11 or the hub 12 along a common circumferential circle.

However, it should be noted that a rotationally symmetrical arrangement or an arrangement which is uniform in the circumferential direction, that is to say a configuration and arrangement which is regular in the circumferential direction, is advantageous in order to avoid the occurrence of nonuniform rotational forces, in particular unbalances.

To ensure that the spokes 14 to 23 each extend obliquely as described above, the position Y1 or Y2 of the radially outer attachment point of a spoke 14 to 23 in the Y direction differs in each case from the position Y3 or Y4 of the radially inner attachment point of this spoke 14 to 23.

For this purpose, in this exemplary embodiment of a wheel 10 according to the invention, the attachment points Y1 of the radially outer ends of the spokes 14 to 18 on the rim 11 or the first rim circumferential circle HA in the Y direction are situated further toward the vehicle interior than the associated attachment points Y3 of the radially inner ends of the spokes 14 to 18 on the hub 12 or the first hub circumferential circle NU1.

Correspondingly, for this purpose, the attachment points Y2 of the radially outer ends of the spokes 19 to 23 on the rim 11 or the second rim circumferential circle FU2 in the Y direction are situated further to the vehicle exterior than the associated attachment points Y4 of the radially inner ends of the spokes 19 to 23 on the hub 12 or the second hub circumferential circle NU2.

The spokes 14 to 18 here extend from the hub 12 to the rim along their longitudinal direction L in each case at a first angle α1 to the rotation axis, and the spokes 19 to 23 extend at a second angle α2, wherein, in the depicted exemplary embodiments, the angular magnitudes of the angles α1 and α2 are in each case the same. However, they can also be chosen to be different.

In this wheel 10, the spokes 14 to 18 of the first group and the spokes 19 to 23 of the second group are here arranged in particular in an alternating manner in the circumferential direction and their attachment points on the hub 12 or the rim 11 each chosen in such a way that, when considering a radial section through the wheel 10 along a section plane containing the rotation axis D of the wheel, and with a projection of two adjacently arranged spokes in the circumferential direction into this section plane, for example the spokes 14 and 19 or the spokes 15 and 20 or the spokes 16 and 21 or 17 and 22 or 18 and 23, these spokes form an X, as schematically illustrated in FIG. 2, wherein, in this case, a distance ΔFU between the first rim circumferential circle HA and the second rim circumferential circle FU2 in the Y direction is chosen to be less than a distance ΔNU between the first hub circumferential circle NU1 and the second hub circumferential circle NU2, which results in a crossing of the respective spokes closer to the rim 11 than to the hub 12. Also conceivable in principle are equal distances ΔFU and ΔNU, which lead to a crossing of the spokes 14 to 23 centrally between the rim 11 and the hub 12, and distances for which the following applies: ΔFU>ΔNU, which lead to a crossing closer to the hub.

For particularly good brake ventilation and for a visually particularly appealing configuration, in particular in order to achieve a particularly light and sporty impression of the wheel 10, in the exemplary embodiment shown in FIG. 1, for each of all of the spokes 14 to 23, a width B of the individual spokes in the circumferential direction in each case decreases outwardly in the radial direction, that is to say with increasing distance from the rotation axis D. That is to say that the individual spokes 14 to 23 become narrower outwardly with increasing distance from the rotation axis D, wherein, in this exemplary embodiment, the spokes 14 to 23 preferably become narrower symmetrically to a spoke longitudinal axis. However, this is not absolutely necessary. That is to say that, in principle, asymmetrical configurations of one or more spokes are also conceivable.

By virtue of the two groups of spokes having spokes 14 to 18 or 19 to 23 with the spokes 14 to 23 arranged and designed according to the invention, wherein each of the groups in this exemplary embodiment comprises five spokes or in each case a wheel spider 13A, 13B with in each case five spokes, the forces and moments occurring or arising during travel can be distributed over a total of ten spokes 14 to 23. Here, the arrangement of the individual spokes 14 to 23 allows particularly advantageous utilization of the installation space available within the rim 11. In particular, the embodiment according to the invention of the wheel allows smaller dimensioning of the individual spokes 14 to 23, in particular with a radially outwardly decreasing width B, that is to say with a width B which decreases with an increasing distance from the rotation axis D. This makes it possible in particular to provide a wheel 10 which allows smaller dimensioning of the individual spokes 14 to 23 by comparison with an actual five-spoke wheel and consequently good brake ventilation, but which, in spite of the ten spokes 14 to 23, visually rather gives the impression of a five-spoke wheel.

By contrast, for a particularly effective reduction of the aerodynamic rotation (resistance) moment, it is more advantageous if the spokes 14 to 23 become wider outwardly in the radial direction with increasing distance from the rotation axis D, that is to say if their width B in the circumferential direction increases outwardly. However, the wheel 10 then possibly no longer appears so light. Furthermore, this can have an effect on the cooling air flow to the brake. That is to say that this can lead to varied brake ventilation.

FIG. 3 is a schematic illustration showing a corresponding projection of two adjacent spokes 14 and 19 of a second exemplary embodiment of an alternative wheel 10 according to the invention, with the same reference signs being used for the same components for the benefit of better and simpler understanding.

In this case, the spokes 14 and 19 are for example not designed as in the preceding exemplary embodiment and arranged between the rim 11 and hub 12 in such a way that, when considering a radial section through the wheel 10 along a section plane containing the rotation axis D of the wheel, and with a projection in the circumferential direction of these spokes into the section plane, they form an X, but rather in such a way that, together with a portion of the rim 11 and a portion of the hub 12, form a quadrangle, in particular a trapezoid, in this case with the corner points Y1, Y2, Y3 and Y4. If Y1 and Y2 were to coincide in the Y direction, that is to say ΔFU=0, the two adjacent spokes 14 and 19 would form an inverted V.

Here, the spoke 14 likewise extends obliquely radially outward and toward the interior of the vehicle as in the above-described exemplary embodiment, and the spoke 19 extends obliquely radially outward and toward the vehicle exterior.

Unlike the previous exemplary embodiment, as can be clearly seen on the basis of FIG. 3, in this wheel 10 the attachment point Y1 of the radially outer end of the spoke 14 or of all of the spokes 14 to 18 of the first group is in this case situated further toward the vehicle exterior than the attachment point Y2 of the radially outer end of the adjacent spoke 19 or of the spokes 19 to 23 of the second group, with the result that the spokes do not cross one another. However, this arrangement also allows the above-described advantages to be achieved in principle if sufficient supporting or transmission of the occurring forces and moments between the rim 11 and hub 12 is ensured with this arrangement.

Alternatively, an arrangement of the spokes 14 to 23 in which the spokes 14 to 23 do not cross one another is also conceivable, but in which the following applies: ΔFU>ΔNU (inverted trapezoid) or ΔFU=0 and ΔNU>0 (inverted V) or alternatively ΔFU>0 and ΔNU=0 (V-shaped arrangement).

Apart from these described exemplary embodiments, a large number of variants and modified embodiments are conceivable, in particular embodiments with a different number of spokes and with a different configuration of the individual spokes that is optimized in particular in details. In particular, both more and fewer spokes per group or wheel spider are possible and also a different number of spokes of the groups or else more than two groups of spokes. However, the total number of all the spokes is preferably less than 16, in particular less than 14 or 12. The number of spokes per group is in particular equal to or less than eight, in particular equal to or less than six, particularly preferably, as in the exemplary embodiment illustrated in FIG. 1, in each case five spokes.

Likewise, the wheel or one or more spokes can have additional aerodynamic measures, in particular for further reduction of a rotation (resistance) moment occurring during travel. For example, one or more of the spokes can additionally be designed as a double spoke in the rotation axis direction D, for example as in DE 10 2016 216 536 A1 stated at the outset, or can have correspondingly suitable flow contours, such as, for example, one or more separation edges or dimples (depressions like a golf ball) or the like. There can also be provided one or more annular disks which are at least partially or completely closed in the circumferential direction.

Moreover, various further modifications and embodiments in addition to the explained modifications and embodiments are possible, in particular design modifications, without departing from the content of the patent claims.

### LIST OF REFERENCE SIGNS

10 Wheel according to the invention
11 Rim
12 Hub
13A, 13B Wheel spider
14 to 23 Spokes
14 to 18 Spokes of the first group
19 to 23 Spokes of the second group
24 Rim edge
α1 First angle (internal angle with respect to the rotation axis)
α2 Second angle (internal angle with respect to the rotation axis)
B Spoke width
D Rotation axis
ΔFU Distance between rim circumferential circles
ΔNU Distance between hub circumferential circles
FU1, FU2 Rim circumferential circle
L Spoke longitudinal axis
NU1, NU2 Hub circumferential circle
U Circumferential direction
Y Vehicle transverse direction
Y1-Y4 Position in vehicle transverse direction

1-14. (canceled)

15. A wheel for a vehicle, comprising:
a rim;
a hub; and
a plurality of spokes arranged in a distributed manner in a circumferential direction and each having a radially inner end and a radially outer end, wherein
the hub is arranged asymmetrically to a vertical wheel center plane extending perpendicularly to a rotation axis direction of the wheel,
each spoke is connected to the rim by its radially outer end and to the hub by its radially inner end, such that the rim is connected to the hub by the spokes, and
with respect to a functional installation state of the wheel in the vehicle, at least two of the spokes are fastened to the rim by their radially outer end at different positions in a vehicle transverse direction and/or at least two of the spokes are fastened to the hub by their radially inner end at different positions in the vehicle transverse direction.

16. The wheel according to claim 15, wherein
with respect to the functional installation state of the wheel in the vehicle, two spokes arranged adjacently in the circumferential direction are fastened to the rim by their radially outer end at different positions in the vehicle transverse direction and/or to the hub by their radially inner end at different positions in the vehicle transverse direction.

17. The wheel according to claim 15, wherein the wheel comprises at least two groups of spokes:
a first group of spokes whose radially outer end is in each case fastened to the rim at a first position in the vehicle transverse direction along a first rim circumferential circle, and
at least one second group of spokes whose radially outer end is in each case fastened to the rim at a second position in the vehicle transverse direction along a second rim circumferential circle.

18. The wheel according to claim 17, wherein the wheel comprises at least two groups of spokes:
a first group of spokes whose radially inner end is in each case fastened to the hub at a first position in the vehicle transverse direction along a first hub circumferential circle, and
at least one second group of spokes whose radially inner end is in each case fastened to the hub at a second position in the vehicle transverse direction along a second hub circumferential circle.

19. The wheel according to claim 18, wherein
at least one first spoke of the first group is fastened to the rim by its radially outer end along the first rim circumferential circle and to the hub by its radially inner end along the first hub circumferential circle, and
at least one second spoke of the second group arranged adjacently to a first spoke in the circumferential direction is fastened to the rim by its radially outer end along the second rim circumferential circle and to the hub by its radially inner end along the second hub circumferential circle.

20. The wheel according to claim 17, wherein
at least one first spoke of the first group is fastened to the rim by its radially outer end along the first rim circumferential circle and to the hub by its radially inner end along the first hub circumferential circle, and
at least one second spoke of the second group arranged adjacently to a first spoke in the circumferential direction, is fastened to the rim by its radially outer end along the second rim circumferential circle and to the hub by its radially inner end along the second hub circumferential circle.

21. The wheel according to claim 17, wherein
the spokes of the first group and the spokes of the second group are arranged in a regularly alternating manner.

22. The wheel according to claim 18, wherein
the spokes of the first group and the spokes of the second group are arranged in a regularly alternating manner.

23. The wheel according to claim 18, wherein
at least one first spoke extends from the hub up to the rim with its longitudinal axis at a first defined angle to the rotation axis, and
at least one second spoke arranged adjacently to a first spoke in the circumferential direction extends from the hub up to the rim with its longitudinal axis at a second defined angle to the rotation axis,
wherein the at least one first spoke and/or the at least one second spoke extend or extends in a plane which is common with the rotation axis.

24. The wheel according to claim 23, wherein
the at least one first spoke extends from the hub obliquely radially outward and toward the vehicle interior up to the rim; and
the at least one second spoke extends from the hub obliquely radially outward and toward the vehicle exterior up to the rim.

25. The wheel according to claim 23, wherein the first angle and the second angle have a same angular magnitude.

26. The wheel according to claim 23, wherein the first angle and the second angle have different angular magnitudes.

27. The wheel according to claim 18, wherein
with respect to the functional installation state of the wheel in the vehicle, a distance in the vehicle transverse direction between the first rim circumferential circle and the second rim circumferential circle and also a distance between the first hub circumferential circle and the second hub circumferential circle and also the first angle and the second angle are each chosen such that:
when considering a radial section through the wheel along a section plane containing the rotation axis of the wheel, and with a projection in the circumferential direction of two adjacently arranged spokes into the section plane, these spokes form an X, a V, an inverted V or, together with a portion of the rim and a portion of the hub, a quadrangle.

28. The wheel according to claim 15, wherein
a width of at least one spoke in the circumferential direction increases outwardly in the radial direction with increasing distance from the rotation axis of the wheel.

29. The wheel according to claim 28, wherein the increase is symmetrically to a spoke longitudinal axis

30. The wheel according to claim 15, wherein
a width of at least one spoke in the circumferential direction decreases outwardly in the radial direction with increasing distance from the rotation axis of the wheel.

31. The wheel according to claim 30, wherein the decrease is symmetrically to a spoke longitudinal axis.

32. The wheel according to claim 15, wherein
at least one spoke of the wheel has an additional further aerodynamic feature.

33. A motor vehicle comprising a wheel according to claim 15.

34. The vehicle according to claim 33, wherein the vehicle is a two-track motor vehicle.
